(19) United States
(12) Patent Application Publication
(10) Pub. No.: US 2025/0315307 A1
(43) Pub. Date: Oct. 9, 2025

(54) ORCHESTRATION OF ITERATIVE QUBO COMPILATION AND EXECUTION IN A QUBO CUTTING SCHEME

(71) Applicant: Dell Products L.P., Round Rock, TX (US)

(72) Inventors: Brendan Burns Healy, Haddonfield, NJ (US); Miguel Paredes Quiñones, Campinas (BR)

(21) Appl. No.: 18/627,285

(22) Filed: Apr. 4, 2024

(51) Int. Cl. G06F 17/11

(52) U.S. Cl. CPC G06F 9/5038; G06F 9/4881; G06F 17/11; G06F 2209/5017; G06F 2209/5019

(57) ABSTRACT

One example method includes cutting a quadratic unconstrained binary optimization (QUBO) problem to obtain k sub-QUBOs Qᵢᵢ∀i=1 . . . k to be solved, identifying dependencies among the k sub-QUBOs, creating a list that indicates the dependencies, using the dependencies, predicting, for one i, a time îⱼ to solve every sub-QUBO

$${Q}_{j j}^{l - 1} ∀ j ∈ {Ω}_{i} ,$$

predicting a time \dot{t}ᵢ to compile

$${Q}_{ii}^{l} ,$$

and estimating, using the time \hat{t}ⱼ and the time \dot{t}ᵢ, a total compilation time tᵢ for the sub-QUBO

$${Q}_{ii}^{l} .$$

### FIELD OF THE INVENTION

Embodiments of the present invention generally relate to QUBO (quadratic unconstrained binary optimization) problem compilation and execution. More particularly, at least some embodiments of the invention relate to systems, hardware, software, computer-readable media, and methods, for generating a queue of QUBO compilation and execution, based on an iterative prediction of QUBO compilation.

### BACKGROUND

A QUBO is a type of problem that may be solved using a solver such as an annealer. The size and complexity of QUBOs may vary. Large QUBOs, for example, can present particular problems at least because a user may not have hardware, such as real quantum hardware, large enough to solve a given QUBO. As another example, simulation on classical hardware of a large QUBO may be prohibitive, given that the required classical resources, and time to solution, scale quadratically with QUBO size.

Given these considerations, approaches have been devised for cutting QUBOs into sub-QUBOs which may then be solved more readily. However, it is not currently possible to optimize job orchestration for the sub-QUBO jobs because the current methods of runtime prediction will not work for these jobs.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example method according to an embodiment.

FIG. 2 discloses aspects of an example embodiment of a computing entity, which may comprise classical and/or quantum components, including annealers, configured and operable to perform part, or all, of any of the disclosed methods, processes, and operations.

### DETAILED DESCRIPTION OF SOME EXAMPLE EMBODIMENTS

Embodiments of the present invention generally relate to QUBO (quadratic unconstrained binary optimization) problem compilation and execution. More particularly, at least some embodiments of the invention relate to systems, hardware, software, computer-readable media, and methods, for generating a queue of QUBO compilation and execution, based on an iterative prediction of QUBO compilation.

One example embodiment comprises a method which, when carried out, generates a prediction as to an amount of time needed to compile a sub-QUBO that was obtained by a QUBO cutting scheme. Correspondingly, the prediction generated by this embodiment may be used to allocate and orchestrate resources for compilation of the QUBO using classical hardware. One example of such a method comprises the following operations: performing QUBO cutting of Q to obtain k sub-QUBOs Qᵢᵢ∀i=1 . . . k to be solved; creating a list of solution dependencies of the k sub-QUBOs; for one i, using a first ML (machine learning) model M to predict time \hat{t}ⱼ to solve every

$${Q}_{j j}^{l - 1} ∀ j ∈ {Ω}_{i} ;$$

using a second ML model L to predict a time \dot{t}ᵢ to compile

$${Q}_{ii}^{l} ;$$

and estimating a time tᵢ to compile

$${Q}_{i i}^{l} .$$

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that sub-QUBO jobs obtained by a QUBO cutting process may be evaluated in terms of their dependency on each other. An embodiment may enable allocation of resources for compilation of a QUBO. An embodiment may predict an amount of time needed to compile one or more sub-QUBOs. Various other advantages of one or more example embodiments will be apparent from this disclosure.

### A. Context For an Example Embodiment

As noted above, a QUBO cutting process may be employed, for example, in circumstances where there is no real quantum hardware large enough to solve a given QUBO, and/or where simulation would be prohibitive, in terms of time and computing resources required, using classical computing resources.

To make QUBO cutting feasible, an embodiment may consider the problem of separating the original QUBO which was to be solved, into k groups with (i) a minimum number of monomials, and (ii) non-zero coefficients between the k groups. The output of this process will be a portioned matrix as shown below.

$$Q = ( \begin{matrix}{Q}_{1 , 1} & … & {Q}_{1 , N} \\ ⋮ & ⋱ & ⋮ \\ {Q}_{N , 1} & … & {Q}_{N , N}\end{matrix} )$$

Each iteration of this algorithm may run N number of QUBO problems, and one set of values

$${x}_{i}^{l}$$

at iteration l generates a solution P_{i,l}. These individual sub-QUBOs Q_{1,1} through Q_{N,N} may now be run on separate respective annealers in parallel, or possibly on fewer nodes in series. So, then every i QUBO problem Qᵢ at iteration l is:

$${p}_{i , l} : {min}_{{x}_{i}} {x}_{j}^{T} {Q}_{j , j} {x}_{j} + {\sum }_{j ∈ {Ω}_{i}} {x}_{i}^{T} {Q}_{i j} {x}_{j}^{l - 1}$$

Where Q_{i,i} is the diagonal block matrix (above) representing the sub-QUBO only using variables in that block, and Q_{i,j} is the part of the QUBO matrix representing the interaction of variables in subsets i and j. This heuristic enables saving of a current solution x^{l} and iteration may be continued until a local minimum is obtained, or a number of L iterations have been performed.

Note that when running the first iteration of this process, x^{l} will be a vector of all zeros, unless a warm-start was used, which means the Q_{i,j} (for i,j distinct) contribution will be zero. Only after the x vector has been updated at least once will these interactions be considered by the annealer.

With the foregoing in view, an example embodiment comprises a prediction method for iterative compilation of sub-QUBOs, using the above form of a QUBO cutting solution which is iterative and easy to be parallelized. This parallelization may benefit from correct predictions about the next compilation of sub-QUBOS. In doing so, an embodiment may produce a more accurate prediction of runtime which is not achievable otherwise, which may enable more optimal resource allocation for solution of the QUBO.

An embodiment may employ a QUBO cutting process. One example of such a QUBO cutting process may comprise dividing the binary variables into two or more disjoint sets of variables and then evaluates the separate submatrices, obtaining values for each set independently at every iteration. In the next iterations, all solutions coming from last iteration are passed to update Sub-QUBOs. The compilation of one sub-QUBO depends on the solution of sub-QUBOs that share variables with it. Then, a waiting list for QUBO compilation and execution may be scheduled.

### B. Detailed Aspects of an Example Embodiment

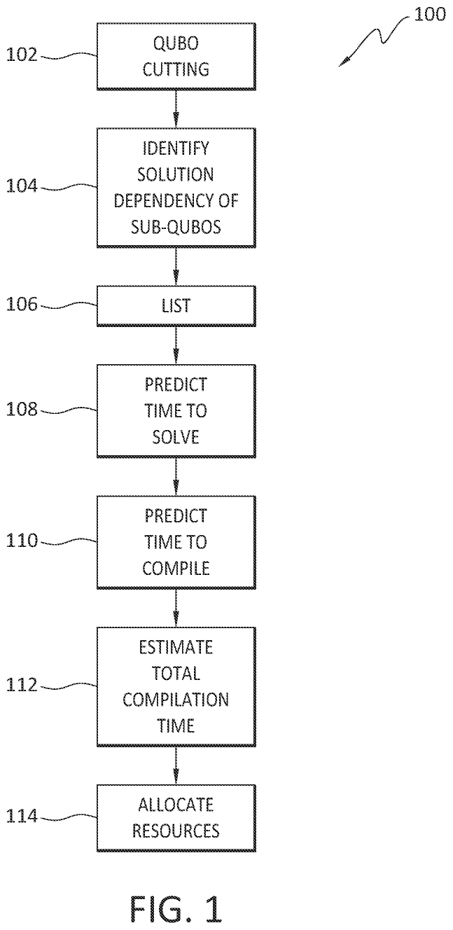

With attention now to FIG. 1, an example method according to one embodiment is denoted at 100. One embodiment may assume that there is a QUBO cutting scheme being executed in an iterative way. An embodiment comprises a method to create a queue of QUBO compilation and execution based on an iterative prediction of QUBO compilation. Example QUBO cutting schemes that may be employed in an embodiment are disclosed in U.S. patent application Ser. No. 18/321,474 filed May 22, 2023, and entitled QUADRATIC UNCONSTRAINED BINARY OPTIMIZATION CUTTING, which is incorporated herein in its entirety by this reference.

The example method 100 may begin with the cutting 102 of a QUBO into a group of k sub-QUBOs. For example, the cutting 102 may comprise cutting of a QUBO Q to obtain k sub-QUBOs Qᵢᵢ∀i=1 . . . k to be solved. In an embodiment, the cutting 102 may be performed, for example, as a result of a determination that the QUBO cannot be practically solved, as a whole, by available quantum computing hardware or classical computing hardware.

Next, a dependency between/among the respective solutions of the individual sub-QUBOs may be identified 104. Then, a list of the respective solution dependencies of the k sub-QUBOs may be created 106. In more detail, creation 106 of the list may enable solving a sub-QUBO Qᵢᵢ at iteration l (that is,

$${Q}_{i i}^{l} = {x}_{i}^{T} {Q}_{i i} {x}_{i} + {\sum }_{j} {x}_{i}^{T} {Q}_{i j} {x}_{j}^{l - 1} ) ,$$

since the solution of that sub-QUBO is based on the previous solution

$${x}_{j}^{l - 1} ,$$

and also depends on the respective solutions of those sub-QUBOs Qᵢⱼ that are non-zero, as indicated in the foregoing equation. Note that in an embodiment, the list of non-zero sub-QUBOs Qᵢⱼ for a given i is Ωᵢ={j: Qᵢⱼ≈0}.

With regard to zero, and non-zero, QUBOs, and with respect to generation 106 of the list, it is noted that for two example diagonal blocks, Qᵢᵢ and Qⱼⱼ, the update of the value of one does not affect the other, if the off-diagonal block Qⱼⱼ is identically equal to zero. That is, the QUBO is symmetric, so this is the same condition as if Qⱼⱼ is identically zero. Accordingly, for any fixed i, an embodiment may make 106 a list of indices {j} for which Qⱼⱼ is non-zero, and thus indicating a dependence.

After the solution dependencies have been identified 104, and the solution dependency list created 106, an ML model M may be used to predict 108, for one i, a time \hat{t}ⱼ to solve every original sub-QUBO

$${Q}_{j j}^{l - 1} ∀ j ∈ {Ω}_{i} .$$

Example embodiments of an approach to make the time prediction 108 are disclosed in U.S. patent application Ser. No. 18/321,207, filed May 22, 2023, entitled ESTIMATING EXECUTION METRICS OF DIFFERENT ANNEALERS FOR SLO OPTIMIZATION, and incorporated herein it its entirety by this reference.

Next, an ML model L may be used to predict 110 time \dot{t}ᵢ to compile

$${Q}_{i i}^{l} .$$

Example embodiments of an approach to make the prediction 110 are disclosed in U.S. patent application Ser. No. 18/321,230, filed May 22, 2023, entitled DYNAMIC ORCHESTRATION OF QUADRATIC UNCONSTRAINED BINARY OPTIMIZATION COMPILATION AND EXECUTION, and incorporated herein in its entirety by this reference.

A total compilation time tᵢ for the sub-QUBO

$${Q}_{i i}^{l}$$

may then be estimated 112. Estimation of tᵢ depends on \dot{t}ᵢ and \hat{t}ⱼ ∀j∈Ωᵢ. From this, an embodiment may also derive and use

$${t}_{i}^{m} ,$$

which is the total compilation time for the sub-QUBO Qᵢ including all iterations l from 1 . . . m. In an embodiment, this total compilation time tᵢ may be used to allocate resources 114, which may comprise classical computing hardware, to be used for the compilation of the sub-QUBO

$${Q}_{ii}^{l} .$$

The method 100 may be applied equally to other sub-QUBOs obtained through a cutting process such as the process 102. In this way, an aggregate amount of time and resources needed to support solving the original QUBO Q, as a whole, may be determined.

### C. Further Discussion

As will be apparent from this disclosure, one or more embodiments may possess various useful features and aspects, although no embodiment is required to possess any such features or aspects. The following examples are illustrative. An embodiment may comprise a method and framework for evaluating the dependency of sub-QUBO jobs resulting from a QUBO cutting process. An embodiment may use such a framework for the prediction of total, and step-wise, time to compile a sub-QUBO in a QUBO cutting scheme.

### D. Example Methods

It is noted with respect to the disclosed methods, including the example method of FIG. 1, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### E. Further Example Embodiments

Following are some further example embodiments of the invention. These are presented only by way of example and are not intended to limit the scope of the invention in any way.

Embodiment 1. A method, comprising: cutting a quadratic unconstrained binary optimization (QUBO) problem to obtain k sub-QUBOs Qᵢᵢ∀i=1 . . . k to be solved; identifying dependencies among the k sub-QUBOs; creating a list that indicates the dependencies; using the dependencies, predicting, for one i, a time \hat{t}ⱼ to solve every sub-QUBO

$${Q}_{j j}^{l - 1} ∀ j ∈ {Ω}_{i} ;$$

predicting a time \dot{t}ᵢ to compile

$${Q}_{ii}^{l} ;$$

and estimating, using the time \hat{t}ⱼ and the time \dot{t}ᵢ, a total compilation time \dot{t}ᵢ for the sub-QUBO

$${Q}_{i i}^{l} .$$

Embodiment 2. The method as recited in any preceding embodiment, wherein a first machine learning (ML) model M is used to predict the time \hat{t}ᵢ to solve every sub-QUBO

$${Q}_{j j}^{l - 1} ∀ j ∈ {Ω}_{i} .$$

Embodiment 3. The method as recited in any preceding embodiment, wherein a second ML model L is used to predict the time \dot{t}ᵢ to compile

$${Q}_{i i}^{l} .$$

Embodiment 4. The method as recited in any preceding embodiment, wherein the cutting is performed based on a determination that the QUBO cannot be practically solved using available quantum computing hardware, or classical computing hardware.

Embodiment 5. The method as recited in any preceding embodiment, wherein creating the list comprises making a list of indices {j} for which Qⱼⱼ is non-zero, and accordingly indicates a dependency.

Embodiment 6. The method as recited in any preceding embodiment, wherein the dependencies comprise dependencies among respective solutions of the k sub-QUBOs.

Embodiment 7. The method as recited in any preceding embodiment, wherein a total compilation time tᵢ for the sub-QUBO

$${Q}_{i i}^{l}$$

is used to derive a total compilation time

$${t}_{i}^{m}$$

for sub-QUBO Qᵢ including all iterations l from 1 . . . m.

Embodiment 8. The method as recited in any preceding embodiment, wherein the total compilation time tᵢ for the sub-QUBO

$${Q}_{i i}^{l}$$

is used as a basis to identify and allocate resources needed for compilation of the sub-QUBO

$${Q}_{i i}^{l} .$$

Embodiment 9. The method as recited in embodiment 18, wherein the resources comprise classical computing hardware.

Embodiment 10. The method as recited in any preceding embodiment, wherein the sub-QUBO

$${Q}_{i i}^{l}$$

is a member of a queue in which the sub-QUBOs Qᵢᵢ∀i=1 . . . k are iteratively placed for compilation and execution, and the sub-QUBO

$${Q}_{ii}^{l}$$

and the sub-QUBOs Qᵢᵢ ∀i=1 . . . k are iteratively placed in the queue based on the predicted time \hat{t}ⱼ and the predicted time \dot{t}ᵢ.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

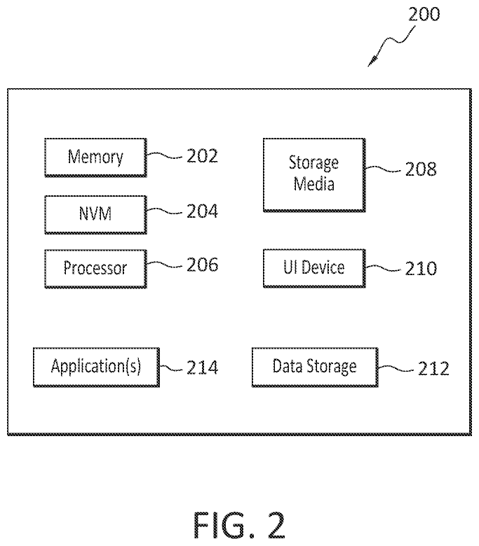

With reference briefly now to FIG. 2, any one or more of the entities disclosed, or implied, by FIG. 1, and/or elsewhere herein, may take the form of, or include, or be implemented on, or hosted by, a physical computing device, one example of which is denoted at 200. As well, where any of the aforementioned elements comprise or consist of a virtual machine (VM), that VM may constitute a virtualization of any combination of the physical components disclosed in FIG. 2.

An embodiment of the computing device 200, or another computing device, may comprise quantum hardware, classical computing hardware, or a combination of quantum and classical computing hardware. By way of example, one embodiment may employ an annealer which may comprise, or consist of, classical computing components such as memory and processors for example. One embodiment may employ an annealer that comprises, or consists, of a quantum annealer. An annealer according to one embodiment may be a digital annealer, or a simulated annealer. No particular type or configuration of annealer is required in any embodiment however. In one embodiment, an explainer may comprise, or consist of, classical computing components.

In the example of FIG. 2, the physical computing device 200 includes a memory 202 which may include one, some, or all, of random access memory (RAM), non-volatile memory (NVM) 204 such as NVRAM for example, read-only memory (ROM), and persistent memory, one or more hardware processors 206, non-transitory storage media 208, UI device 210, and data storage 212. One or more of the memory components 202 of the physical computing device 200 may take the form of solid state device (SSD) storage. As well, one or more applications 214 may be provided that comprise instructions executable by one or more hardware processors 206 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
cutting a quadratic unconstrained binary optimization (QUBO) problem to obtain k sub-QUBOs Qᵢᵢ∀i=1 . . . k to be solved;
identifying dependencies among the k sub-QUBOs;
creating a list that indicates the dependencies;
using the dependencies, predicting, for one i, a time \hat{t}ⱼ to solve every sub-QUBO
$${Q}_{jj}^{l - 1} ∀ j ∈ {Ω}_{i} ;$$
predicting a time \dot{t}ᵢ to compile
$${Q}_{i i}^{l} ;$$
and
estimating, using the time \hat{t}ⱼ and the time \dot{t}ᵢ, a total compilation time tᵢ for the sub-QUBO
$${Q}_{i i}^{l} .$$

2. The method as recited in claim 1, wherein a first machine learning (ML) model M is used to predict the time \hat{t}ⱼ to solve every sub-QUBO
$${Q}_{j j}^{l - 1} ∀ j ∈ {Ω}_{i} .$$

3. The method as recited in claim 1, wherein a second ML model L is used to predict the time \dot{t}ᵢ to compile
$${Q}_{i i}^{l} .$$

4. The method as recited in claim 1, wherein the cutting is performed based on a determination that the QUBO cannot be practically solved using available quantum computing hardware, or classical computing hardware.

5. The method as recited in claim 1, wherein creating the list comprises making a list of indices {j} for which Qⱼⱼ is non-zero, and accordingly indicates a dependency.

6. The method as recited in claim 1, wherein the dependencies comprise dependencies among respective solutions of the k sub-QUBOs.

7. The method as recited in claim 1, wherein a total compilation time tᵢ for the sub-QUBO
$${Q}_{i i}^{l}$$
is used to derive a total compilation time
$${t}_{i}^{m}$$
for sub-QUBO Qᵢ including all iterations l from 1 . . . m.

8. The method as recited in claim 1, wherein the total compilation time tᵢ for the sub-QUBO
$${Q}_{i i}^{l}$$
is used as a basis to identify and allocate resources needed for compilation of the sub-QUBO
$${Q}_{i i}^{l} .$$

9. The method as recited in claim 8, wherein the resources comprise classical computing hardware.

10. The method as recited in claim 1, wherein the sub-QUBO
$${Q}_{i i}^{l}$$
is a member of a queue in which the sub-QUBOs Qᵢᵢ∀i=1 . . . k are iteratively placed for compilation and execution, and the sub-QUBO
$${Q}_{i i}^{l}$$
and the sub-QUBOs Qᵢᵢ∀i=1 . . . k are iteratively placed in the queue based on the predicted time \hat{t}ⱼ and the predicted time \dot{t}ᵢ.

11. A non-transitory storage medium having stored therein instructions that are executable by one or more hardware processors to perform operations comprising:
cutting a quadratic unconstrained binary optimization (QUBO) problem to obtain k sub-QUBOs Qᵢᵢ∀i=1 . . . k to be solved;
identifying dependencies among the k sub-QUBOs;
creating a list that indicates the dependencies;
using the dependencies, predicting, for one i, a time \hat{t}ⱼ to solve every sub-QUBO
$${Q}_{j j}^{l - 1} ∀ j ∈ {Ω}_{i} ;$$
predicting a time \dot{t}ᵢ to compile
$${Q}_{ii}^{l} ;$$
and
estimating, using the time \hat{t}ⱼ and the time \dot{t}ᵢ, a total compilation time tᵢ for the sub-QUBO
$${Q}_{ii}^{l} .$$

12. The non-transitory storage medium as recited in claim 11, wherein a first machine learning (ML) model M is used to predict the time \hat{t}ⱼ to solve every sub-QUBO
$${Q}_{j j}^{l - 1} ∀ j ∈ {Ω}_{i} .$$

13. The non-transitory storage medium as recited in claim 11, wherein a second ML model L is used to predict the time \dot{t}ᵢ to compile
$${Q}_{ii}^{l} .$$

14. The non-transitory storage medium as recited in claim 11, wherein the cutting is performed based on a determination that the QUBO cannot be practically solved using available quantum computing hardware, or classical computing hardware.

15. The non-transitory storage medium as recited in claim 11, wherein creating the list comprises making a list of indices {j} for which Qⱼⱼ is non-zero, and accordingly indicates a dependency.

16. The non-transitory storage medium as recited in claim 11, wherein the dependencies comprise dependencies among respective solutions of the k sub-QUBOs.

17. The non-transitory storage medium as recited in claim 11, wherein a total compilation time tᵢ for the sub-QUBO
$${Q}_{ii}^{l}$$
is used to derive a total compilation time
$${t}_{i}^{m}$$
for sub-QUBO Qᵢ including all iterations l from 1 . . . m.

18. The non-transitory storage medium as recited in claim 11, wherein the total compilation time tᵢ for the sub-QUBO
$${Q}_{i i}^{l}$$
is used as a basis to identify and allocate resources needed for compilation of the sub-QUBO
$${Q}_{ii}^{l} .$$

19. The non-transitory storage medium as recited in claim 18, wherein the resources comprise classical computing hardware.

20. The non-transitory storage medium as recited in claim 11, wherein the sub-QUBO
$${Q}_{ii}^{l}$$
is a member of a queue in which the sub-QUBOs Qᵢᵢ∀i=1 . . . k are iteratively placed for compilation and execution, and the sub-QUBO
$${Q}_{ii}^{l}$$
and the sub-QUBOs Qᵢᵢ∀i=1 . . . k are iteratively placed in the queue based on the predicted time \hat{t}ⱼ and the predicted time \dot{t}ᵢ.
